(19) United States
(12) Patent Application Publication
(10) Pub. No.: US 2025/0046054 A1
(43) Pub. Date: Feb. 6, 2025

(54) METHOD, APPARATUS, STORAGE MEDIUM, AND ELECTRONIC DEVICE FOR FEATURE EXTRACTION

(71) Applicants: Beijing Bytedance Network Technology Co., Ltd., Beijing (CN); Lemon Inc., Grand Cayman (KY)

(72) Inventors: Chong WANG, Los Angeles, CA (US); Lin ZHENG, Beijing (CN)

(21) Appl. No.: 18/717,239

(22) PCT Filed: Mar. 17, 2023
(86) PCT No.: PCT/CN2023/082352

§ 371 Date: Jun. 6, 2024

(30) Foreign Application Priority Data
Mar. 30, 2022 (CN) 202210334325.8

(51) Int. Cl. G06V 10/48; G06F 17/18

(52) U.S. Cl. CPC G06V 10/48; G06F 17/18

(57) ABSTRACT

The disclosure relates to a method, an apparatus, a storage medium, an electronic device, a computer program product, and a computer program for feature extraction, device. The method includes: determining target data for a feature to be extracted, and determining, based on the target data, a plurality of query vectors, a plurality of key vectors, and a plurality of value vectors; determining a plurality of key-value pair information corresponding to each of the query vectors; and performing, for each of the query vectors, a random mapping based on the query vector and the plurality of data samples, to obtain a plurality of random query vectors, and determining feature information corresponding to the query vector based on the plurality of random query vectors and the plurality of key-value pair information.

### CROSS REFERENCE

The present disclosure claims priority to a Chinese patent application filed to the Chinese Patent Office on Mar. 30, 2022, entitled “Method, apparatus, storage medium, and electronic device for feature extraction” with Application No. 202210334325.8, which is hereby incorporated by reference in its entirety.

### FIELD

The present disclosure relates to the field of data processing, specifically to a method, an apparatus, a storage medium, an electronic device, a computer program product, and a computer program for feature extraction.

### BACKGROUND

With the continuous development of computer technology, neural network models may model the relationship between any two elements in an input sequence through self-attention mechanism, thereby capturing dependency relationships between long-distance elements in the input sequence. There are various attention mechanisms in related arts, among which the Random Feature Attention (RFA) mechanism may linearize the function for similarity computation in traditional self-attention mechanisms to improve computational efficiency. However, the RFA mechanism is a biased estimation with a significant approximation error, which may affect the accuracy of output results of the model.

### SUMMARY

This summary section is provided to briefly introduce the ideas, which will be described in the following detail description section. This summary section is neither intended to identify the key or necessary features of the technical solution requiring protection, nor is it intended to limit the scope of the technical solution requiring protection.

In a first aspect, the present disclosure provides a method for feature extraction, and the method comprises:
determining target data for a feature to be extracted, and determining, based on the target data, a plurality of query vectors, a plurality of key vectors, and a plurality of value vectors;
determining a plurality of key-value pair information corresponding to each of the query vectors, wherein each of the key-value pair information is determined based on the plurality of key vectors, the plurality of value vectors, and a data sample, and the plurality of data samples for determining the plurality of key-value pair information are obtained by sampling based on a plurality of probability distributions, the plurality of probability distributions are determined based on the plurality of query vectors; and
performing, for each of the query vectors, a random mapping based on the query vector and the plurality of data samples, to obtain a plurality of random query vectors, and determining feature information corresponding to the query vector based on the plurality of random query vectors and the plurality of key-value pair information.

In a second aspect, the present disclosure provides an apparatus for feature extraction, and the apparatus comprises:
a first determining module configured to determine target data for a feature to be extracted, and determine, based on the target data, a plurality of query vectors, a plurality of key vectors, and a plurality of value vectors;
a second determining module configured to determine a plurality of key-value pair information corresponding to each of the query vectors, wherein each of the key-value pair information is determined based on the plurality of key vectors, the plurality of value vectors, and a data sample, and the plurality of data samples for determining the plurality of key-value pair information are obtained by sampling based on a plurality of probability distributions, the plurality of probability distributions are determined based on the plurality of query vectors; and
a third determining module configured to perform, for each of the query vectors, a random mapping based on the query vector and the plurality of data samples, to obtain a plurality of random query vectors, and determine feature information corresponding to the query vector based on the plurality of random query vectors and the plurality of key-value pair information.

In a third aspect, the present disclosure provides a non-transitory computer-readable medium, having a computer program stored thereon, wherein the program, when executed by a processing device, implements the method of the first aspect.

In a fourth aspect, the present disclosure provides an electronic device, comprising:
a storage unit having a computer program stored thereon;
a processing unit configured to execute the computer program in the storage unit to implement the method of the first aspect.

In a fifth aspect, the present disclosure provides a computer program product, comprising: a computer program, wherein the program, when executed by a processing device, implements the method of the first aspect.

In a sixth aspect, the present disclosure provides a computer program, wherein the program, when executed by a processing device, implements the method of the first aspect.

The other features and advantages of the present disclosure will be explained in detail in the subsequent detailed description section.

### BRIEF DESCRIPTION OF THE DRAWINGS

By combining drawings and referring to the following detailed description, the above and other features, advantages, and aspects of each embodiment disclosed in the present disclosure will become more prominent. Throughout the figures, the same or similar figure markers indicate the same or similar elements. It should be understood that the drawings are illustrative, and the original and elements may not necessarily be drawn to scale. In the drawings:

FIG. 1 is a schematic diagram of the process of a traditional attention mechanism;

FIG. 2 is a schematic diagram of the process of an attention mechanism based on random features;

FIG. 3 is a flowchart of a method for feature extraction according to an example embodiment of the present disclosure;

FIG. 4 is a schematic diagram of the process of a method for feature extraction according to an example embodiment of the present disclosure;

FIG. 5 is a block diagram of an apparatus for feature extraction according to an example embodiment of the present disclosure; and

FIG. 6 is a block diagram of an electronic device according to an example embodiment of the present disclosure.

### DETAILED DESCRIPTION

It can be understood that before using the technical solutions disclosed in each embodiment of the present disclosure, users should be informed and authorized by relevant laws and regulations in an appropriate manner regarding the types, scope of use, and usage scenarios of personal information involved in the present disclosure.

For example, in response to receiving an active request of a user, a prompt message is sent to the user to clearly indicate that the requested operation will require obtaining and using the personal information of the user. Thus, users may selectively choose whether to provide personal information to software or hardware such as electronic devices, applications, servers, or storage media that perform the operation of the disclosed technical solution based on the prompt information.

As an optional but non-restrictive implementation, in response to receiving the active request of the user, sending prompt information to the user may be done in the form of a pop-up window, where prompt information may be presented in text. In addition, the pop-up window may also carry a selection control for users to choose between “agree” or “disagree” to provide personal information to electronic devices.

It can be understood that the above notification and observer user authorization process are only illustrative and do not limit the implementation methods of the present disclosure. Other methods that comply with relevant laws and regulations may also be applied to the implementation methods of the present disclosure. At the same time, it can be understood that the data involved in this technical solution (including but not limited to the data itself, data observation or use) should comply with the requirements of corresponding laws, regulations and relevant provisions.

In the following, the drawings are used to provide a more detailed description of the embodiments of the present disclosure. Although certain embodiments of the present disclosure are shown in the drawings, it should be understood that the present disclosure may be implemented in various forms and should not be construed as limited to the embodiments described herein. Instead, these embodiments are provided for a more thorough and complete understanding of the present disclosure. It should be understood that the drawings and attachments of the present disclosure are for illustrative purposes only and are not intended to limit the scope of protection of the present disclosure.

It should be understood that the various steps recorded in the embodiments of the disclosed methods may be executed in different orders and/or in parallel. In addition, the method implementation may include additional steps and/or omitting the steps shown for execution. The scope of the present disclosure is not limited in this regard.

The term “including” and its variations used in this article are open-ended, meaning “including but not limited to”. The term “based on” means “based at least in part on”. The term “one embodiment” means “at least one embodiment”. The term “another embodiment” means “at least one other embodiment”. The term “some embodiments” means “at least some embodiments”. The relevant definitions of other terms will be provided in the following description.

It should be noted that the concepts such as “first” and “second” mentioned in the present disclosure are only used to distinguish different devices, modules or units, and are not intended to limit the order or interdependence of the functions performed by these devices, modules or units. Furthermore, it should be noted that the modifications referred to as “one” or “a plurality of” in the present disclosure are illustrative rather than restrictive, and those skilled in the art should understand that unless otherwise explicitly stated in the context, they should be understood as “one or more”.

The names of the messages or information exchanged between a plurality of devices in the embodiments of the present disclosure are for illustrative purposes only and are not intended to limit the scope of these messages or information.

With the continuous development of computer technology, neural network models may model the relationship between any two elements in an input sequence through self-attention mechanism, thereby capturing dependency relationships between long-distance elements in the input sequence. For example, the Transformer model models input sequences through self-attention mechanisms and is widely used in fields such as natural language processing, computer vision, and audio processing.

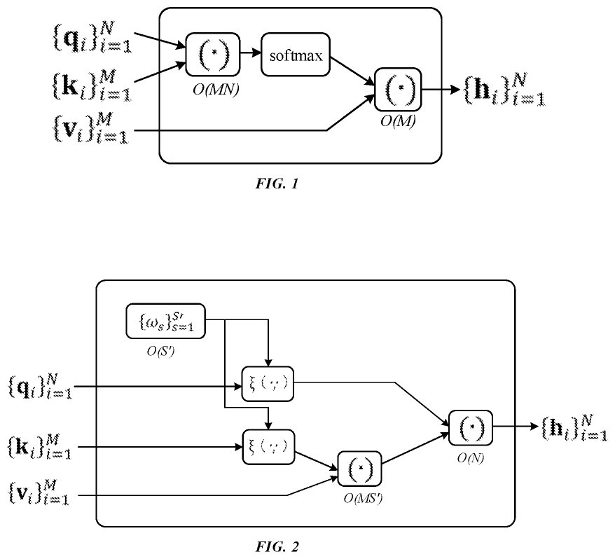

The traditional self-attention mechanism has three groups of inputs: N query vectors, M key vectors, and M value vectors, where N and M are positive integers, and typically N equals M. In the Transformer model, the query vector, the key vector, and the value vector are all obtained by transforming the input sequence. Referring to FIG. 1, (·) represents dot product operation, O represents computational complexity. The traditional self-attention mechanism firstly compares each of the query vectors ({qᵢ}ᵢ₌₁^{N}) with each of the key vectors ({kᵢ}ᵢ₌₁^{M}), and computes the similarity between each of the query vectors and each of the key vectors. Then, after normalization using the softmax function, all value vectors ({vᵢ}ᵢ₌₁^{M}) are weighted and averaged based on the similarities to obtain the final feature information ({hᵢ}ᵢ₌₁^{N}). In simple terms, the computational order of the traditional self-attention mechanism is (QK) V, where Q represents a matrix composed of query vectors, K represents a matrix composed of key vectors, and V represents a matrix composed of query vectors.

The traditional self-attention mechanism, which compares each of the query vectors and each of the key vectors in pairs when computing similarity, may capture dependency relationships between long-distance elements in the input sequence and has strong feature expression ability. However, the research of the inventor found that this method of comparing each of the query vectors and each of the key vectors in pairs results in a squared level computational complexity, as shown in FIG. 1, the computational complexity of QK computation is O(MN). For longer sequences (such as images, videos, documents, protein sequences, or the like), this squared level computational complexity may become a bottleneck for model operation.

Related arts may compress the input sequence to adapt to the structure of the Transformer to reduce computational complexity, but the accuracy reduction caused by compression is usually significant. Related arts have also proposed various variants of self-attention mechanisms, such as using sparse matrices, low rank matrices for approximate computations, to reduce computational complexity. The Random Feature Attention (RFA) mechanism may linearize the function for similarity computation in traditional self-attention mechanisms, thereby achieving high computational efficiency, and may reduce memory usage while accelerating execution speed. Specifically, the processing process of the RFA mechanism is as follows.

Referring to FIG. 2, ωₛ represents the s^{th} sample, S′ represents the total number of the samples (S′ is a positive integer), ξ(·,·) represents random mapping. The RFA mechanism firstly samples a group of samples ({ωₛ}ₛ₌₁^{s′}) based on the standard normal distribution, and then shares this group of samples in all query vectors. Therefore, for each sample ωₛ, the key-value pair information may be computed in advance as follows:

$${N}_{s} = {\sum }_{m = 1}^{M} ξ ( {k}_{m} , {ω}_{s} ) {v}_{m}$$

Nₛ represents the key-value pair information determined by the s^{th} sample.

In another aspect, the RFA mechanism computes a normalization factor in advance as follows:

$${D}_{s} = {\sum }_{m = 1}^{M} ξ ( {k}_{m} , {ω}_{s} )$$

Dₛ represents the normalization factor determined by the s^{th} sample.

Finally, the RFA mechanism applies the pre-computed key-value pair information and the normalization factor to each of the query vectors in the following way to obtain the corresponding feature information for each of the query vectors:

$$\begin{matrix}N = {\sum }_{s = 1}^{S ′} ξ ( {q}_{n} , {ω}_{s} ) {N}_{s} \\ D = {\sum }_{s = 1}^{S ′} ξ ( {q}_{n} , {ω}_{s} ) {D}_{s}\end{matrix}$$

$${y}_{n} = N / D$$

γₙ represents the feature information corresponding to the n^{th} query vector, where n is a positive integer greater than 0 and less than N.

In simple terms, the RFA mechanism is equivalent to changing the computational order of (QK) V to Q (KV). Because the main computational bottleneck of the traditional self-attention mechanism lies in the computation of QK, changing the computational order may reduce the computational complexity from squared level to linear. As shown in FIG. 2, the computational complexity of KV computation is 0 (MS′). O(S′) is the computational complexity of the sampling process, and it does not vary with the input sequence, therefore the computational complexity is usually low.

However, the RFA mechanism shares a group of samples obtained from the standard normal distribution for all query vectors, that is, using the same processing method for all query vectors cannot capture fine-grained feature correlation information between different query vectors, resulting in significant approximation errors and affecting the accuracy of output results of the model.

In view of this, the present disclosure provides a new method for feature extraction to reduce approximation errors and improve the accuracy of output results of the model.

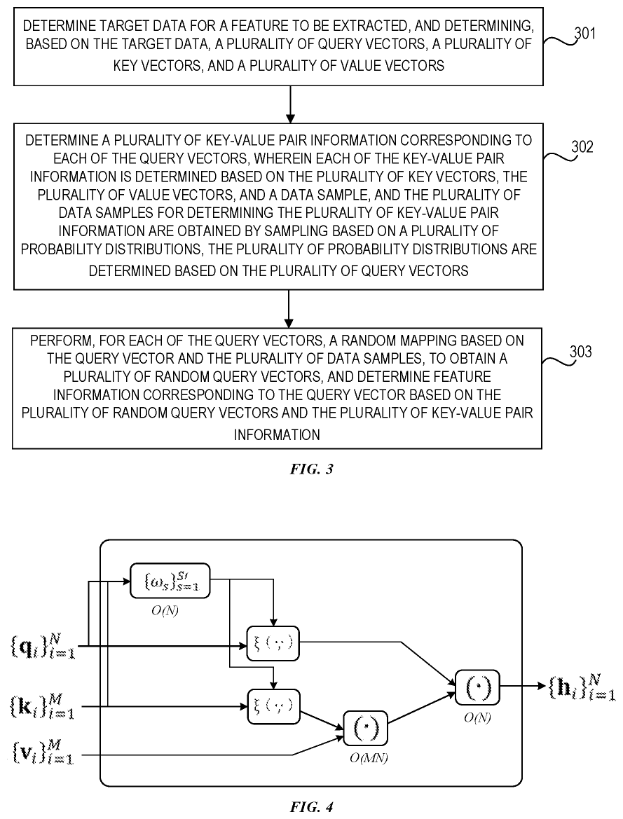

FIG. 3 is a flowchart of a method for feature extraction illustrated based on an example embodiment of the present disclosure. Referring to FIG. 3, the method for feature extraction comprises the following steps.

Step 301, target data for a feature to be extracted is determined, and a plurality of query vectors, a plurality of key vectors, and a plurality of value vectors are determined based on the target data.

Step 302, a plurality of key-value pair information corresponding to each of the query vectors are determined, wherein each of the key-value pair information is determined based on the plurality of key vectors, the plurality of value vectors, and a data sample, and the plurality of data samples for determining the plurality of key-value pair information are obtained by sampling based on a plurality of probability distributions, the plurality of probability distributions are determined based on the plurality of query vectors.

Step 303, for each of the query vectors, a random mapping is performed based on the query vector and the plurality of data samples, to obtain a plurality of random query vectors, and feature information corresponding to the query vector is determined based on the plurality of random query vectors and the plurality of key-value pair information.

Through the above solution, the plurality of data samples for determining the plurality of key-value pair information are obtained by sampling based on a plurality of probability distributions, the plurality of probability distributions are determined based on the plurality of query vectors. Therefore, the query vectors are different, corresponding different key-value pair information may be determined. In the process of determining the feature information based on the key-value pair information, different processing methods may be applied to different query vectors to capture finer grained feature correlation information between query vectors, to reduce approximation errors, and to obtain high-level feature information that better represents the semantics of the target data.

In order to help technical personnel in this field better understand the method for feature extraction provided by the present solution, the above steps will be further explained below.

In an embodiment, in the step 301, image data may be determined as the target data for the feature to be extracted. Correspondingly, the feature information corresponding to each of the query vectors may be used to determine an image classification result of the image data.

For example, the method for feature extraction provided in the present disclosure is combined with the Transformer model, that is, the content of feature extraction based on the built-in attention mechanism in the Transformer model is replaced with the content of the method for feature extraction provided in the present disclosure. In this scenario, if the image data is determined as the target data for the feature to be extracted, after obtaining the feature information corresponding to each of the query vectors, the feature information may be input into a classifier of the Transformer model to obtain the image classification result of the image data.

In another embodiment, in the step 301, video data may be determined as the target data for the feature to be extracted. Correspondingly, the feature information corresponding to each of the query vectors may be used to determine a video action recognition result of the video data.

For example, the method for feature extraction provided in the present disclosure is combined with the Transformer model, that is, the content of feature extraction based on the built-in attention mechanism in the Transformer model is replaced with the content of the method for feature extraction provided in the present disclosure. In this scenario, if the video data is determined as the target data for the feature to be extracted, after obtaining the feature information corresponding to each of the query vectors, the feature information may be input into a recognition module of the Transformer model to obtain the video action recognition result of the video data.

In another embodiment, in the step 301, text data may be determined as the target data for the feature to be extracted. Correspondingly, after the step 303, a translation of the text data may be determined based on the feature information corresponding to each of the query vectors.

For example, the method for feature extraction provided in the present disclosure is combined with the Transformer model, that is, the content of feature extraction based on the built-in attention mechanism in the Transformer model is replaced with the content of the method for feature extraction provided in the present disclosure. In this scenario, if the text data is determined as the target data for the feature to be extracted, after obtaining the feature information corresponding to each of the query vectors, the feature information may be input into an embedding module of the Transformer model to obtain the translation of the text data.

It should be understood that in the embodiments of the present disclosure, the target data is input into the Transformer model, the Transformer model may firstly perform a feature embedding operation on the target data to obtain an initial feature vector corresponding to the target data. For example, if the target data is the text data, after the feature embedding operation, the initial feature vector is a word vector corresponding to each word segment in the text data. Afterwards, the plurality of query vectors, the plurality of key vectors, and the plurality of value vectors may be determined based on the initial feature vectors corresponding to the target data.

For example, each initial feature vector corresponding to the target data may be multiplied with a first weight matrix to obtain the plurality of query vectors. Each initial feature vector corresponding to the target data may be multiplied with a second weight matrix to obtain the plurality of key vectors. Each initial feature vector corresponding to the target data may be multiplied with a third weight matrix to obtain the plurality of value vectors. It should be understood that the first weight matrix, the second weight matrix, and the third weight matrix are different, and other contents of determining the query vectors, the key vectors, and the value vectors based on target data may refer to relevant techniques, which will not be repeated here.

After obtaining the plurality of query vectors, the plurality of key vectors, and the plurality of value vectors, at step 302 the key-value pair information corresponding to each of the query vectors may be determined.

In an embodiment, determining the key-value pair information corresponding to each of the query vectors may be: determining a probability distribution based on each of the query vectors, and performing, according to a first predetermined quantity, a sampling based on the probability distribution corresponding to each of the query vectors, to obtain the plurality of data samples corresponding to each of the query vectors. Then, for each of the query vectors, the plurality of key-value pair information are determined based on the plurality of key vectors, the plurality of value vectors, and the plurality of data samples corresponding to the query vector.

For example, the first predetermined quantity is used to represent an expected quantity of samples, which may be set according to the actual situation, and the present disclosure does not limit this. Determining the probability distribution based on each of the query vectors may be taking the value of each of the query vectors as the expected value (μ) to determine the corresponding probability distribution. For example, if there are three query vectors with values of 0.1, 2, and −10 respectively, the probability distributions of expected values of 0.1, 2, and −10 may be determined. Afterwards, for each probability distribution, the plurality of data samples may be obtained by sampling according to the first predetermined quantity. For example, if the first predetermined quantity is 10, 10 data samples may be sampled under each probability distribution.

Therefore, referring to FIG. 4, for each of the query vectors, a group of samples may be sampled separately, and then the key-value pair information may be computed separately based on the separately sampled samples. Compared to the method in which all query vectors in related arts share a group of samples sampled by the standard normal distribution, different processing methods may be adopted for each of the query vectors because different query vectors correspond to different groups of samples in the embodiments of the present disclosure, which has stronger feature expression ability and may capture more fine-grained feature association information between query vectors, obtaining high-level feature information that may better represent the semantics of the target data.

However, the above method separately samples a group of samples for each of the query vectors, which cannot compute the key-value pair information in advance. Instead, corresponding key-value pair information needs to be computed separately for each of the query vectors, resulting in high computational complexity. As shown in FIG. 4, the computational complexity of the sampling process is related to the input sequence, which is O(N), and the computational complexity of KV computation is O(MN). In order to balance the computational complexity and the computational accuracy, the present disclosure further provides another way to determine the key-value pair information.

In another embodiment, determining the key-value pair information corresponding to each of the query vectors may be: firstly dividing the plurality of query vectors into a plurality of query vector groups according to a second predetermined quantity, then determining a probability distribution based on each of the query vector groups, and sampling a data sample based on the probability distribution corresponding to each of the query vector groups, to obtain the plurality of data samples. Next, key-value pair information is determined based on each of the data samples, the plurality of key vectors, and the plurality of value vectors, to obtain a plurality of shared key-value pair information. At last, the plurality of shared key-value pair information is determined as the plurality of key-value pair information corresponding to each of the query vectors.

The second predetermined quantity is used to represent an expected quantity of query vector groups, and the second predetermined quantity is smaller than a quantity of the plurality of query vectors. The second predetermined quantity may be set according to the actual situation, and the present disclosure does not limit it.

For example, dividing the plurality of query vectors into the plurality of query vector groups based on the second predetermined quantity may be dividing the plurality of query vectors equally into the plurality of query vector groups based on the second predetermined quantity. For example, if the second predetermined quantity is 4 and the quantity of the query vectors is 20, the plurality of query vectors may be equally divided into 4 query vector groups based on the second predetermined quantity. Each of the query vectors groups includes 5 query vectors, and each of the query vector groups includes different query vectors. Alternatively, if the plurality of query vectors cannot be equally divided into the plurality of query vector groups based on the second predetermined quantity, they may be divided according to the actual situation. For example, if the second predetermined quantity is 2 and the quantity of the query vectors is 5, a query vector group consisting of 2 query vectors and another query vector group consisting of 3 query vectors may be divided. The present disclosure does not limit the way query vector groups are divided.

After dividing the query vector groups, a probability distribution may be determined based on each of the query vectors groups. For example, an average value of all query vectors in each of the query vectors groups is determined, and then the average value is used as an expected value (p) to determine the corresponding probability distribution. Therefore, the corresponding probability distribution may be determined for each of the query vectors groups, and the plurality of data samples may be obtained by sampling a data sample based on each of the probability distributions. Afterwards, the plurality of query vectors may share the plurality of data samples, that is, key-value pair information may be determined based on each of the data samples, the plurality of key vectors, and the plurality of value vectors, to obtain the plurality of shared key-value pair information. At last, the plurality of shared key-value pairs may be reused into each of the query vectors.

Through the above method, each of the query vectors may correspond to a sample sampled from the plurality of probability distributions, and the plurality of probability distributions are determined by the query vector groups corresponding to the plurality of query vectors. Compared to the method in related arts where all query vectors share a group of samples sampled from the standard normal distribution, different processing methods may be used for the plurality of query vectors to capture finer grained feature correlation information between query vectors, thereby obtaining high-level feature information that better characterizes the semantics of the target data. In addition, because the plurality of query vectors share samples sampled from the plurality of probability distributions, corresponding key-value pair information may be computed in advance based on the samples sampled from each of the probability distributions, instead of separately computing key-value pair information for each of the query vectors, which may achieve the reuse of the key-value pair information, thereby reducing the computational complexity of the feature extraction process, and improving the computational efficiency of the feature extraction process.

After determining the key-value pair information corresponding to each of the query vectors, for each of the query vectors, a random mapping is performed based on the query vector and the plurality of data samples, to obtain a plurality of random query vectors. For example, if the quantity of the query vectors is A1 and the quantity of the data samples is A2, for each of the query vectors, the random mapping may be performed based on the query vector and the data samples to obtain A2 random query vectors corresponding to each of the query vectors.

Afterwards, in step 303, the feature information corresponding to the query vector may be determined based on the plurality of random query vectors and the plurality of key-value pair information.

In some possible ways, a first similarity between a probability distribution corresponding to each of the query vector groups and a probability distribution corresponding to the plurality of query vector groups, and determining may be determined firstly, and for each of the query vectors, a second similarity between the query vector and an average query vector of each of the query vector groups is determined. Then, computational weights are determined based on the first similarity and the second similarity. At last, based on the computational weights, a weighted summation is performed on the plurality of random query vectors and the plurality of key-value pair information, to obtain the feature information corresponding to the query vector.

The first similarity between the probability distribution corresponding to each of the query vectors groups and the probability distribution corresponding to the plurality of query vector groups may be computed as follows:

$$\frac{{q}_{c} ( {ω}_{c} )}{{\sum }_{c = 1}^{C ′} {q}_{c} ( {ω}_{c} )}$$

q_{c}(ω_{c}) represents the probability distribution corresponding to the c^{th} query vector group, ω_{c} represents the data samples sampled from the probability distribution corresponding to the c^{th} query vector group, and C′ represents the quantity of query vector groups.

The second similarity between the query vector and the average query vector of each of the query vectors group may be computed as: exp(qₙ^{T}\tilde{q}_{c}), where qₙ^{T} represents a transpose vector of the n^{th} query vector qₙ, and \tilde{q}_{c} represents an average query vector of the c^{th} query vector group.

Alternatively, for each of the query vectors, the second similarity may be obtained by combining a normalization computation as follows:

$$\frac{exp ( {q}_{n}^{T} {\tilde{q}}_{c} )}{{\sum }_{n = 1}^{N} exp ( {q}_{n}^{T} {\tilde{q}}_{c} )}$$

Certainly, the first similarity and the second similarity may also be determined based on other methods other than those described above, and the present disclosure does not limit them. For example, in the method of combining the normalization computation to obtain the second similarity, the sum of denominators may further be performed based on the quantity of the query vector groups, that is, the second similarity may be determined as follows:

$$\frac{exp ( {q}_{n}^{T} {\tilde{q}}_{c} )}{{\sum }_{i = 1}^{C ′} exp ( {q}_{n}^{T} {\tilde{q}}_{i} )}$$

After obtaining the first similarity and the second similarity, the computational weights may be determined based on the first similarity and the second similarity.

In some possible ways, for each of the query vector groups, a sum of the first similarity and the second similarity corresponding to the query vector group is determined as the computational weights. Alternatively, for each of the query vector groups, a sum of the first similarity and the second similarity corresponding to the query vector group is determined as a total similarity. Based on the second similarity corresponding to each of the query vector groups, an average similarity between the query vector and an average query vector of the plurality of query vector groups is determined, and the average similarity is subtracted from the total similarity to obtain the computational weights.

For example, the computational weights may be determined as follows:

$${α}_{nc} ( {ω}_{c} ) = \frac{{q}_{c} ( {ω}_{c} )}{{\sum }_{c = 1}^{C ′} {q}_{c} ( {ω}_{c} )} + \frac{exp ( {q}_{n}^{T} {\tilde{q}}_{c} )}{{\sum }_{n = 1}^{N} exp ( {q}_{n}^{T} {\tilde{q}}_{c} )}$$

α_{nc}(ω_{c}) represents the computational weight of the n^{th} query vector and the c^{th} query vector group.

For another example, the computational weight may be determined as follows

$${α}_{nc} ( {ω}_{c} ) = \frac{{q}_{c} ( {ω}_{c} )}{{\sum }_{c = 1}^{C ′} {q}_{c} ( {ω}_{c} )} + {γ}_{nc}^{′} - \frac{1}{{C}^{′}} {\sum }_{c = 1}^{{C}^{′}} {γ}_{nc}^{′}$$

$${γ}_{nc}^{′} = \frac{exp ( {q}_{n}^{T} {\tilde{q}}_{c} )}{{\sum }_{n = 1}^{N} exp ( {q}_{n}^{T} {\tilde{q}}_{c} )}$$

γ′_{nc} represents the second similarity and

$$\frac{1}{{C}^{′}} {\sum }_{c = 1}^{C ′} {γ}_{nc}^{′}$$

represents the average similarity.

Next, the feature information corresponding to each of the query vectors may be determined as follows:

$$\begin{matrix}N = {\sum }_{c = 1}^{C ′} {α}_{nc} ( {ω}_{c} ) ξ ( {q}_{n} , {ω}_{c} ) {N}_{c} \\ D = {\sum }_{c = 1}^{C ′} {α}_{nc} ( {ω}_{c} ) ξ ( {q}_{n} , {ω}_{c} ) {D}_{c}\end{matrix}$$

$${y}_{n} = N / D$$

N_{c} represents the key-value pair information determined by the c^{th} query vector group, and De represents the normalization factor determined by the c^{th} query vector group.

By using the above method, the plurality of query vectors share a sample sampled from the plurality of probability distributions. Furthermore, a weighted summation is performed on the plurality of random query vectors and the plurality of key-value pair information obtained by the sample, to obtain final feature information. The computational weights may vary according to the different query vectors, so that the final feature information may change with the change of the query vector. Compared with the RFA mechanism in related arts, more fine-grained feature correlation information between query vectors may be captured, and high-level feature information that better represents the semantics of the target data may be obtained.

In some possible ways, for the probability distribution corresponding to each of the query vector groups, an importance sampling weight corresponding to the probability distribution is determined based on the probability distribution and a standard normal distribution. Correspondingly, a product of the computational weight and the importance sampling weight may be determined firstly as a target computational weight; and based on the target computational weight, the weighted summation is performed on the plurality of random query vectors and the plurality of key-value pair information, to obtain the feature information corresponding to the query vector.

It should be understood that since the computational weight is determined based on the probability distribution corresponding to the query vector group, the probability distribution may deviate from the actual probability distribution corresponding to a single query vector, resulting in errors between the extracted feature information and the actual feature information corresponding to the target data. Therefore, the embodiments of the present disclosure may firstly determine the importance sampling weight corresponding to the probability distribution based on the probability distribution and the standard normal distribution, and then apply the importance sampling weight to the weighted summation process of the random query vector and the key-value pair information. The importance sampling weight is equivalent to a correction term, which may reduce the error between the extracted feature information and the actual feature information corresponding to the target data.

For example, the importance sampling weight may be determined first as follows:

$${α}_{nc}^{′} ( {ω}_{c} ) = p ( {ω}_{c} ) / {q}_{c} ( {ω}_{c} )$$

p(ω_{c}) represents the standard normal distribution.

Then, the computational weight and the importance sampling weight determined by any of the above methods may be multiplied to obtain the target computational weight. At last, based on the target computational weight, the weighted summation is performed on the plurality of random query vectors and the plurality of key-value pair information to obtain the feature information corresponding to the query vectors. That is, the feature information corresponding to each of the query vectors may be determined as follows:

$${α}_{nc}^{′} ( {ω}_{c} ) = {α}_{nc} ( {ω}_{c} ) p ( {ω}_{c} ) / {q}_{c} ( {ω}_{c} )$$

$$\begin{matrix}N = {\sum }_{c = 1}^{C ′} {α}_{nc}^{′} ( {ω}_{c} ) ξ ( {q}_{n} , {ω}_{c} ) {N}_{c} \\ D = {\sum }_{c = 1}^{C ′} {α}_{nc}^{′} ( {ω}_{c} ) ξ ( {q}_{n} , {ω}_{c} ) {D}_{c}\end{matrix}$$

$${y}_{n} = N / D$$

α′_{nc}(ω_{c}) represents the target computational weight.

By using the above method, the weighted summation is performed on the plurality of random query vectors and the plurality of key-value pair information obtained from the sample, to obtain the final feature information. The computational weight may vary according to different query vectors, so that the final feature information may change with the change of the query vectors. Compared with the RFA mechanism in related arts, more fine-grained feature correlation information between query vectors may be captured, and high-level feature information that better represents the semantics of the target data may be obtained. In addition, since the plurality of query vectors share samples sampled from the plurality of probability distributions, corresponding key-value pair information may be computed in advance based on the samples sampled from each of the probability distributions, instead of separately computing key-value pair information for each of the query vectors, thereby achieving reuse of the key-value pair information, reducing the computational complexity of the feature extraction process, and improving the computational efficiency of the feature extraction process.

The following illustrates the technical effectiveness of the method for feature extraction provided in the present disclosure through application scenarios of image classification, video action recognition, and machine translation.

In the application scenario of image classification, for the same dataset, related arts adopt a combination of a PVT-v2-b4 model and a Performer mechanism. Based on the method of the present disclosure, the above method for feature extraction based on the query vector group is combined with the PVT-v2-b4 model. The PVT-v2-b4 model is a Transformer model among related arts, FLOPs are used to characterize the computational complexity, and Top-1 Acc represents accuracy. Referring to Table 1, compared to related arts, the method based on the present disclosure has improved accuracy while reducing computational complexity, which may better balance the computational efficiency and the accuracy.

TABLE 1

| | FLOPs | Top-1 Acc |
|---|---|---|
| Related arts | 11.9G | 82.7 |
| The method based on the | 11.3G | 84.0 |
| present disclosure | | |

In the application scenario of video action recognition, for a K400 dataset and an SSv2 dataset, the related arts adopt the Performer mechanism. The method 1 based on the present disclosure is a method for feature extraction that determines a random distribution based on each of the query vector groups. The method 2 based on the present disclosure is a method for feature extraction that determines a random distribution based on each of the query vectors. Accuracy 1 represents the accuracy for the K400 dataset, and accuracy 2 represents the accuracy for the SSv2 dataset. Referring to Table 2, compared to related arts, both the method 1 and the method 2 of the present disclosure have improved accuracy on different datasets, which may improve the accuracy of the output results of the model.

TABLE 2

| | Accuracy 1 | Accuracy 2 |
|---|---|---|
| Related arts | 72.1 | 53.1 |
| The method 1 based on the | 77.5 | 63.7 |
| present disclosure | | |
| The method 2 based on the | 78.2 | 64.9 |
| present disclosure | | |

In the application scenario of machine translation, for the same dataset, related arts adopt a Linformer mechanism. The method based on the present disclosure is a method for feature extraction that determines a random distribution based on each of the query vectors group, and BLEU is used to characterize the accuracy of machine translation. Referring to Table 3, compared to related arts, the translation accuracy based on the method of the present disclosure is improved, thereby improving the accuracy of the output results of the model.

TABLE 3

| | BLEU |
|---|---|
| Related arts | 17.4 |
| The method based on the | 26.4 |
| present disclosure | |

Through the above solution, the plurality of data samples used to determine the key-value pair information are obtained by sampling the plurality of probability distributions, and the plurality of probability distributions are determined based on the plurality of query vectors. Therefore, if the query vectors are different, different corresponding key-value pair information may be determined, thereby in the process of determining the feature information based on the key-value pair information, different corresponding processing methods may be applied to different query vectors to capture finer grained feature association information between query vectors, and thus high-level feature information that better represents the semantics of the target data is obtained.

In addition, in the scenario of determining the feature information based on query vector groups, the computational weights may vary according to the different query vectors, so that the final feature information may change with the change of the query vectors, and finer grained feature correlation information between query vectors is captured. Moreover, in such scenario, since the plurality of query vectors share a sample sampled from the plurality of probability distributions, the corresponding key-value pair information may be computed in advance based on the samples sampled from each of the probability distributions, without the need to separately compute the key-value pair information for each of the query vectors, achieving reuse of the key-value pair information. This may reduce the computational complexity of the feature extraction process and improve the computational efficiency of the feature extraction process.

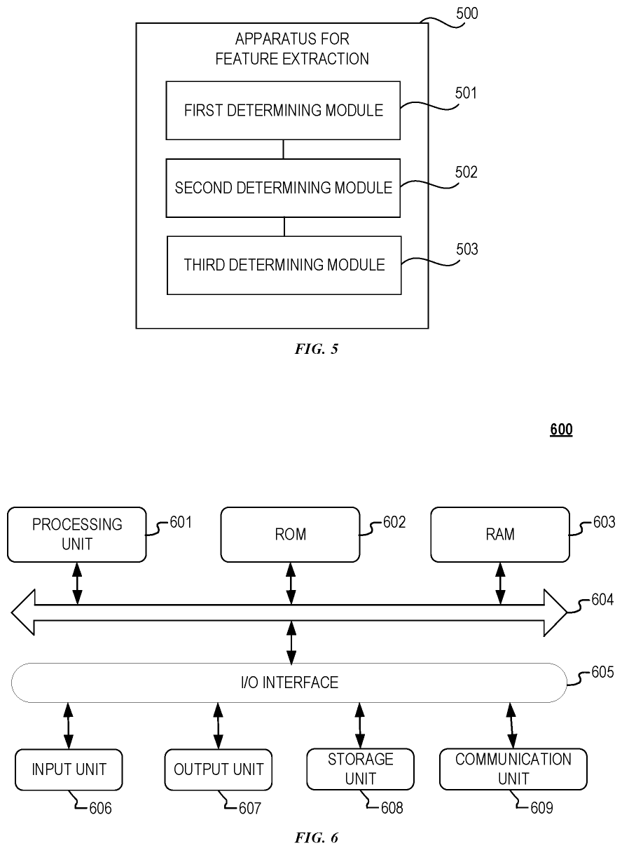

Based on the same concept, the embodiments of the present disclosure further provide an apparatus for feature extraction that may become part or all of an electronic device through software, hardware, or a combination thereof. Referring to FIG. 5, an apparatus for feature extraction 500 comprises:
a first determining module 501 configured to determine target data for a feature to be extracted, and determine, based on the target data, a plurality of query vectors, a plurality of key vectors, and a plurality of value vectors;
a second determining module 502 configured to determine a plurality of key-value pair information corresponding to each of the query vectors, wherein each of the key-value pair information is determined based on the plurality of key vectors, the plurality of value vectors, and a data sample, and the plurality of data samples for determining the plurality of key-value pair information are obtained by sampling based on a plurality of probability distributions, the plurality of probability distributions are determined based on the plurality of query vectors; and
a third determining module 503 configured to perform, for each of the query vectors, a random mapping based on the query vector and the plurality of data samples, to obtain a plurality of random query vectors, and determine feature information corresponding to the query vector based on the plurality of random query vectors and the plurality of key-value pair information.

Alternatively, the second determining module 502 is configured to:
determine a probability distribution based on each of the query vectors, and perform, according to a first predetermined quantity, a sampling based on the probability distribution corresponding to each of the query vectors, to obtain the plurality of data samples corresponding to each of the query vectors, wherein the first predetermined quantity is used to represent an expected quantity of samples; and
determine, for each of the query vectors, the plurality of key-value pair information based on the plurality of key vectors, the plurality of value vectors, and the plurality of data samples corresponding to the query vector.

Alternatively, the second determining module 502 is configured to:
divide the plurality of query vectors into a plurality of query vector groups according to a second predetermined quantity, wherein the second predetermined quantity is used to represent an expected quantity of query vector groups, and the second predetermined quantity is smaller than a quantity of the plurality of query vectors;
determine a probability distribution based on each of the query vector groups, and sample a data sample based on the probability distribution corresponding to each of the query vector groups, to obtain the plurality of data samples;
determine key-value pair information based on each of the data samples, the plurality of key vectors, and the plurality of value vectors, to obtain a plurality of shared key-value pair information; and
determine the plurality of shared key-value pair information as the plurality of key-value pair information corresponding to each of the query vectors.

Alternatively, the third determining module 503 is configured to:
determine a first similarity between a probability distribution corresponding to each of the query vector groups and a probability distribution corresponding to the plurality of query vector groups, and determine, for each of the query vectors, a second similarity between the query vector and an average query vector of each of the query vector groups;
determine computational weights based on the first similarity and the second similarity; and
perform, based on the computational weights, a weighted summation on the plurality of random query vectors and the plurality of key-value pair information, to obtain the feature information corresponding to the query vector.

Alternatively, the apparatus 500 further comprises:
a fourth determining module configured to determine, for the probability distribution corresponding to each of the query vector groups, an importance sampling weight corresponding to the probability distribution based on the probability distribution and a standard normal distribution;
the third determining module 503 is configured to:
determine a product of the computational weight and the importance sampling weight as a target computational weight; and
perform, based on the target computational weight, the weighted summation on the plurality of random query vectors and the plurality of key-value pair information, to obtain the feature information corresponding to the query vector.

Alternatively, the third determining module 503 is configured to:
determine, for each of the query vector groups, a sum of the first similarity and the second similarity corresponding to the query vector group as the computational weights; or
determine, for each of the query vector groups, a sum of the first similarity and the second similarity corresponding to the query vector group as a total similarity, determine, based on the second similarity corresponding to each of the query vector groups, an average similarity between the query vector and an average query vector of the plurality of query vector groups, and subtract the average similarity from the total similarity to obtain the computational weights.

Alternatively, the first determining module 501 is configured to:
determine image data as the target data for the feature to be extracted; and
correspondingly, the feature information corresponding to each of the query vectors being used to determine an image classification result of the image data.

Alternatively, the first determining module 501 is configured to:
determine video data as the target data for the feature to be extracted; and
correspondingly, the feature information corresponding to each of the query vectors being used to determine a video action recognition result of the video data.

Alternatively, the first determining module 501 is configured to:
determine text data as the target data for the feature to be extracted; and
correspondingly, the feature information corresponding to each of the query vectors being used to determine a translation of the text data.

The specific ways in which each module performs operations regarding the apparatus in the above-mentioned embodiments have been described in detail in the embodiments related to this method, and will not be elaborated here.

Based on the same concept, the present disclosure further provides a non-transitory computer-readable medium, having a computer program stored thereon, wherein the program, when executed by a processing device, implements any step of the method for feature extraction.

Based on the same concept, the present disclosure further provides an electronic device comprising:
a storage unit having a computer program stored thereon;
a processing unit configured to execute the computer program in the storage unit to implement any step of the method for feature extraction.

Based on the same concept, the present disclosure further provides a computer program product comprising: a computer program, wherein the program, when executed by a processing device, implements any step of the method for feature extraction.

Based on the same concept, the present disclosure further provides a computer program that implements any step of the method for feature extraction when executed by a processing device.

In the following, referring to FIG. 6, a schematic diagram of a structure of an electronic device 600 suitable for implementing an embodiment of the present disclosure is shown. A terminal device of the embodiments of the present disclosure may include, but is not limited to, a mobile terminal such as a mobile phone, a notebook computer, a digital broadcast receiver, a personal digital assistant (PDA), a portable android device (PAD), a portable media player (PMP), a vehicle-mounted terminal (e.g. a vehicle-mounted navigation terminal), and the like, and a fixed terminal such as a digital TV, a desktop computer, and the like. The electronic device shown in FIG. 6 is only an example and should not impose any limitation on the function and scope of use of the embodiments of the present disclosure.

As shown in FIG. 6, the electronic device 600 may include a processing unit (e.g. a central processor, a graphic processor, etc.) 601 that may execute various suitable actions and processing in accordance with a program stored in a read only memory (ROM) 602 or a program loaded from a storage unit 608 into a random access memory (RAM) 603. In the RAM 603, various programs and data required for the operation of the electronic device 600 are also stored. The processing unit 601, the ROM 602, and the RAM 603 are connected to each other via a bus 604. An input/output (I/O) interface 605 is also connected to the bus 604.

In general, the following apparatuses may be connected to the I/O interface 605: an input unit 606 including, for example, a touch screen, a touch pad, a keyboard, a mouse, a camera, a microphone, an accelerometer, a gyroscope, etc.; an output unit 607 including, for example, a liquid crystal display (LCD), a speaker, a vibrator, etc.; the storage unit 608 including, for example, a magnetic tape, a hard disk, etc.; and a communication unit 609. The communication unit 609 may allow the electronic device 600 to communicate wirelessly or wired with other devices to exchange data. Although FIG. 6 illustrates an electronic device 600 having various units, it should be understood that not all illustrated units are required to be implemented or provided. More or fewer units may alternatively be implemented or provided.

In particular, processes described above with reference to flow diagrams may be implemented as computer software programs in accordance with the embodiments of the present disclosure. For example, an embodiment of the present disclosure includes a computer program product including a computer program carried on a non-transitory computer-readable medium, the computer program including program code for executing the method illustrated in the flow diagram. In such embodiments, the computer program may be downloaded and installed from a network via the communication unit 609, or installed from the storage unit 608, or installed from the ROM 602. When the computer program is executed by the processing unit 601, the above functions defined in the method of an embodiment of the present disclosure is executed.

It needs to be noted that the computer-readable medium described above in the present disclosure may be a computer-readable signal medium or a computer-readable storage medium or any combination of the two. The computer-readable storage medium may be, for example, but not limited to, an electronic, magnetic, optical, electromagnetic, infrared, or semiconductor system, apparatus, or component, or a combination of any of the foregoing. More specific examples of the computer-readable storage medium may include, but are not limited to: an electrical connection having one or more wires, a portable computer diskette, a hard disk, a random access memory (RAM), a read only memory (ROM), an erasable programmable read only memory (EPROM or flash memory), an optical fiber, a portable compact disk-read only memory (CD-ROM), an optical storage device, a magnetic storage device, or any suitable combination thereof. In this disclosure, the computer-readable storage medium may be any tangible medium that can contain or store a program. The program may be used by or in connection with an instruction execution system, apparatus, or device. In this disclosure, a computer-readable signal medium may include a data signal, in which computer-readable program code is carried, propagated in the baseband or as part of a carrier. Such propagated data signal may take many forms, including but not limited to an electromagnetic signal, an optical signal, or any suitable combination of the preceding. The computer-readable signal medium may also be any computer-readable medium other than the computer-readable storage medium. The computer-readable signal medium may send, propagate, or transmit a program for use by or in combination with an instruction execution system, apparatus, or device. The program code contained in the computer-readable medium may be transmitted with any appropriate medium, including but not limited to: a wire, optical cable, RF (radio frequency), etc., or any appropriate combination of the foregoing.

In some implementations, communication may be made using any currently known or future developed network protocol, such as Hypertext Transfer Protocol (HTTP), and may be interconnected with any form or medium of digital data communication (such as communication networks). Examples of communication networks include Local Area Network (LAN), Wide Area Network (WAN), Internet (for example, the Internet), and end-to-end networks (for example, ad hoc end-to-end networks), as well as any currently known or future developed networks.

The computer-readable medium may be included in the electronic device; it may also exist separately and not fitted into the electronic device.

The computer-readable medium carries one or more programs which, when executed by the electronic device, cause the electronic device to: determine target data for a feature to be extracted, and determining, based on the target data, a plurality of query vectors, a plurality of key vectors, and a plurality of value vectors; determine a plurality of key-value pair information corresponding to each of the query vectors, wherein each of the key-value pair information is determined based on the plurality of key vectors, the plurality of value vectors, and a data sample, and the plurality of data samples for determining the plurality of key-value pair information are obtained by sampling based on a plurality of probability distributions, the plurality of probability distributions are determined based on the plurality of query vectors; and perform, for each of the query vectors, a random mapping based on the query vector and the plurality of data samples, to obtain a plurality of random query vectors, and determining feature information corresponding to the query vector based on the plurality of random query vectors and the plurality of key-value pair information.

The computer program code for executing the operations of the present disclosure may be written in one or more programming languages or a combination thereof. The programming languages include but not limited to object-oriented programming languages such as Java, Smalltalk, C++, and conventional procedural programming languages such as “C” language or similar programming languages. The program code may be executed completely on a user computer, partially on a user computer, as one independent software package, partially on a user computer and partially on a remote computer, or completely on a remote computer or server. In the case involving a remote computer, the remote computer may be connected to a user computer through any kind of network, including a local area network (LAN) or a wide area network (WAN), or may be connected to an external computer (e.g. through an Internet connection by using an Internet service provider).

The flowcharts and block diagrams in the drawings illustrate the architecture, functionality, and operation of possible implementations of a system, a method, and a computer program product according to various embodiments of the present disclosure. In this regard, each block in the flowchart or block diagram may represent a module, a program segment, or a portion of code, which contains one or more executable instructions for implementing a specified logical function. It should also be noted that in some alternative implementations, the functions noted in the blocks may occur in other order than those noted in the figures. For example, two successive blocks may in fact be executed substantially in parallel, or they may sometimes be executed in the reverse order, depending upon the functionality involved. It should also be noted that each block in the block diagrams and/or flowcharts, and the combination of blocks in the block diagrams and/or flowcharts, may be implemented by a dedicated hardware-based system that executes the specified function or operation, or may be realized by a combination of dedicated hardware and computer instructions.

The modules involved in the embodiments of the present disclosure may be realized by software or hardware, where the name of a module does not in some cases constitute a limitation on the module itself.

The functions described herein above may be executed, at least in part, by one or more hardware logic parts. For example, without limitation, exemplary types of hardware logic parts that may be used include: a field programmable gate array (FPGA), an application specific integrated circuit (ASIC), an application specific standard product (ASSP), a system on chip (SOC), a complex programmable logic device (CPLD), etc.

In the context of this disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the preceding. More specific examples of the machine-readable storage medium may include an electrical connection based on one or more wires, a portable computer disk, a hard disk, a random access memory (RAM), a read only memory (ROM), an erasable programmable read only memory (EPROM or flash memory), an optical fiber, a portable compact disc read only memory (CD-ROM), an optical storage device, a magnetic storage device, or any suitable combination of the preceding

According to one or more embodiments of the present disclosure, Example 1 provides a method for feature extraction comprising:
determining target data for a feature to be extracted, and determining, based on the target data, a plurality of query vectors, a plurality of key vectors, and a plurality of value vectors;
determining a plurality of key-value pair information corresponding to each of the query vectors, wherein each of the key-value pair information is determined based on the plurality of key vectors, the plurality of value vectors, and a data sample, and the plurality of data samples for determining the plurality of key-value pair information are obtained by sampling based on a plurality of probability distributions, the plurality of probability distributions are determined based on the plurality of query vectors; and
performing, for each of the query vectors, a random mapping based on the query vector and the plurality of data samples, to obtain a plurality of random query vectors, and determining feature information corresponding to the query vector based on the plurality of random query vectors and the plurality of key-value pair information.

According to one or more embodiments of the present disclosure, Example 2 provides a method of Example 1, and the determining a plurality of key-value pair information corresponding to each of the query vectors comprises:
determining a probability distribution based on each of the query vectors, and performing, according to a first predetermined quantity, a sampling based on the probability distribution corresponding to each of the query vectors, to obtain the plurality of data samples corresponding to each of the query vectors, wherein the first predetermined quantity is used to represent an expected quantity of samples; and
determining, for each of the query vectors, the plurality of key-value pair information based on the plurality of key vectors, the plurality of value vectors, and the plurality of data samples corresponding to the query vector.

According to one or more embodiments of the present disclosure, Example 3 provides a method of Example 1, and the determining a plurality of key-value pair information corresponding to each of the query vectors comprises:
dividing the plurality of query vectors into a plurality of query vector groups according to a second predetermined quantity, wherein the second predetermined quantity is used to represent an expected quantity of query vector groups, and the second predetermined quantity is smaller than a quantity of the plurality of query vectors;
determining a probability distribution based on each of the query vector groups, and sampling a data sample based on the probability distribution corresponding to each of the query vector groups, to obtain the plurality of data samples;
determining key-value pair information based on each of the data samples, the plurality of key vectors, and the plurality of value vectors, to obtain a plurality of shared key-value pair information; and
determining the plurality of shared key-value pair information as the plurality of key-value pair information corresponding to each of the query vectors.

According to one or more embodiments of the present disclosure, Example 4 provides a method of Example 3, and the determining feature information corresponding to the query vector based on the plurality of random query vectors and the plurality of key-value pair information comprises:
determining a first similarity between a probability distribution corresponding to each of the query vector groups and a probability distribution corresponding to the plurality of query vector groups, and determining, for each of the query vectors, a second similarity between the query vector and an average query vector of each of the query vector groups;
determining computational weights based on the first similarity and the second similarity; and
performing, based on the computational weights, a weighted summation on the plurality of random query vectors and the plurality of key-value pair information, to obtain the feature information corresponding to the query vector.

According to one or more embodiments of the present disclosure, Example 5 provides a method of Example 4, which further comprises:
determining, for the probability distribution corresponding to each of the query vector groups, an importance sampling weight corresponding to the probability distribution based on the probability distribution and a standard normal distribution;
the performing, based on the computational weights, a weighted summation on the plurality of random query vectors and the plurality of key-value pair information, to obtain the feature information corresponding to the query vector comprising:
determining a product of the computational weight and the importance sampling weight as a target computational weight; and
performing, based on the target computational weight, the weighted summation on the plurality of random query vectors and the plurality of key-value pair information, to obtain the feature information corresponding to the query vector.

According to one or more embodiments of the present disclosure, Example 6 provides a method of Example 4 or 5, and the determining computational weights based on the first similarity and the second similarity comprises:
determining, for each of the query vector groups, a sum of the first similarity and the second similarity corresponding to the query vector group as the computational weights; or
determining, for each of the query vector groups, a sum of the first similarity and the second similarity corresponding to the query vector group as a total similarity, determining, based on the second similarity corresponding to each of the query vector groups, an average similarity between the query vector and an average query vector of the plurality of query vector groups, and subtracting the average similarity from the total similarity to obtain the computational weights.

According to one or more embodiments of the present disclosure, Example 7 provides a method for any of Examples 1 to 5, and the determining target data for a feature to be extracted comprises:
determining image data as the target data for the feature to be extracted; and
correspondingly, the feature information corresponding to each of the query vectors being used to determine an image classification result of the image data.

According to one or more embodiments of the present disclosure, Example 8 provides a method for any of Examples 1 to 5, and the determining target data for a feature to be extracted comprises:
determining video data as the target data for the feature to be extracted; and
correspondingly, the feature information corresponding to each of the query vectors being used to determine a video action recognition result of the video data.

According to one or more embodiments of the present disclosure, Example 9 provides a method for any of Examples 1 to 5, and the determining target data for a feature to be extracted comprises:
determining text data as the target data for the feature to be extracted; and
correspondingly, the feature information corresponding to each of the query vectors being used to determine a translation of the text data.

According to one or more embodiments of the present disclosure, Example 10 provides an apparatus for feature extraction comprising:
a first determining module configured to determine target data for a feature to be extracted, and determine, based on the target data, a plurality of query vectors, a plurality of key vectors, and a plurality of value vectors;
a second determining module configured to determine a plurality of key-value pair information corresponding to each of the query vectors, wherein each of the key-value pair information is determined based on the plurality of key vectors, the plurality of value vectors, and a data sample, and the plurality of data samples for determining the plurality of key-value pair information are obtained by sampling based on a plurality of probability distributions, the plurality of probability distributions are determined based on the plurality of query vectors; and
a third determining module configured to perform, for each of the query vectors, a random mapping based on the query vector and the plurality of data samples, to obtain a plurality of random query vectors, and determine feature information corresponding to the query vector based on the plurality of random query vectors and the plurality of key-value pair information

According to one or more embodiments of the present disclosure, Example 11 provides a non-transitory computer-readable medium, having a computer program stored thereon, wherein the program, when executed by a processing device, implements the method of any of Examples 1 to 9.

According to one or more embodiments of the present disclosure, Example 12 provides an electronic device comprising:
a storage unit having a computer program stored thereon;
a processing unit configured to execute the computer program in the storage unit to implement the method of any of Examples 1 to 9.

Through the above solution, the plurality of data samples for determining the plurality of key-value pair information are obtained by sampling based on a plurality of probability distributions, the plurality of probability distributions are determined based on the plurality of query vectors. Therefore, the query vectors are different, corresponding different key-value pair information may be determined. In the process of determining the feature information based on the key-value pair information, different processing methods may be applied to different query vectors to capture finer grained feature correlation information between query vectors, to reduce approximation errors, and to obtain high-level feature information that better represents the semantics of the target data.

The above description is only preferred embodiments of the present disclosure and explanation of the applied technical principles. Those skilled in the art should understand that the disclosure scope involved in this disclosure is not limited to the technical solutions formed by a specific combination of the above technical features, but should also cover other technical solutions formed by any combination of the above technical features or equivalent features thereof without departing from the above disclosed concept. For example, a technical solution formed by replacing the above-mentioned features and the technical features having similar functions disclosed in (but not limited to) the present disclosure.

Further, while operations are depicted in a particular order, this should not be understood to require that the operations are executed in the particular order shown or in sequential order. Under certain circumstances, multitasking and parallel processing may be advantageous. Likewise, several specific implementation details have been included in the above discussion, but these should not be construed as limiting the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or method and logical acts, it should be understood that the subject matter defined in the appended claims is not necessarily limited to the specific features or acts described above. Rather, the specific features and acts described above are merely example forms for implementing the claims. The specific ways in which each module performs operations regarding the apparatus in the above-mentioned embodiments have been described in detail in the embodiments related to the method, and will not be elaborated here.

1. A method for feature extraction, comprising:
determining target data for a feature to be extracted, and determining, based on the target data, a plurality of query vectors, a plurality of key vectors, and a plurality of value vectors;
determining a plurality of key-value pair information corresponding to each of the query vectors, wherein each of the key-value pair information is determined based on the plurality of key vectors, the plurality of value vectors, and a data sample, and the plurality of data samples for determining the plurality of key-value pair information are obtained by sampling based on a plurality of probability distributions, the plurality of probability distributions are determined based on the plurality of query vectors; and
performing, for each of the query vectors, a random mapping based on the query vector and the plurality of data samples, to obtain a plurality of random query vectors, and determining feature information corresponding to the query vector based on the plurality of random query vectors and the plurality of key-value pair information.

2. The method of claim 1, wherein the determining a plurality of key-value pair information corresponding to each of the query vectors comprises:
determining a probability distribution based on each of the query vectors, and performing, according to a first predetermined quantity, a sampling based on the probability distribution corresponding to each of the query vectors, to obtain the plurality of data samples corresponding to each of the query vectors, wherein the first predetermined quantity is used to represent an expected quantity of samples; and
determining, for each of the query vectors, the plurality of key-value pair information based on the plurality of key vectors, the plurality of value vectors, and the plurality of data samples corresponding to the query vector.

3. The method of claim 1, wherein the determining a plurality of key-value pair information corresponding to each of the query vectors comprises:
dividing the plurality of query vectors into a plurality of query vector groups according to a second predetermined quantity, wherein the second predetermined quantity is used to represent an expected quantity of query vector groups, and the second predetermined quantity is smaller than a quantity of the plurality of query vectors;
determining a probability distribution based on each of the query vector groups, and sampling a data sample based on the probability distribution corresponding to each of the query vector groups, to obtain the plurality of data samples;
determining key-value pair information based on each of the data samples, the plurality of key vectors, and the plurality of value vectors, to obtain a plurality of shared key-value pair information; and
determining the plurality of shared key-value pair information as the plurality of key-value pair information corresponding to each of the query vectors.

4. The method of claim 3, wherein the determining feature information corresponding to the query vector based on the plurality of random query vectors and the plurality of key-value pair information comprises:
determining a first similarity between a probability distribution corresponding to each of the query vector groups and a probability distribution corresponding to the plurality of query vector groups, and determining, for each of the query vectors, a second similarity between the query vector and an average query vector of each of the query vector groups;
determining computational weights based on the first similarity and the second similarity; and
performing, based on the computational weights, a weighted summation on the plurality of random query vectors and the plurality of key-value pair information, to obtain the feature information corresponding to the query vector.

5. The method of claim 4, further comprising:
determining, for the probability distribution corresponding to each of the query vector groups, an importance sampling weight corresponding to the probability distribution based on the probability distribution and a standard normal distribution;
the performing, based on the computational weights, a weighted summation on the plurality of random query vectors and the plurality of key-value pair information, to obtain the feature information corresponding to the query vector comprising:
determining a product of the computational weight and the importance sampling weight as a target computational weight; and
performing, based on the target computational weight, the weighted summation on the plurality of random query vectors and the plurality of key-value pair information, to obtain the feature information corresponding to the query vector.

6. The method of claim 4, wherein the determining computational weights based on the first similarity and the second similarity comprises:
determining, for each of the query vector groups, a sum of the first similarity and the second similarity corresponding to the query vector group as the computational weights; or
determining, for each of the query vector groups, a sum of the first similarity and the second similarity corresponding to the query vector group as a total similarity, determining, based on the second similarity corresponding to each of the query vector groups, an average similarity between the query vector and an average query vector of the plurality of query vector groups, and subtracting the average similarity from the total similarity to obtain the computational weights.

7. The method of claim 1, wherein the determining target data for a feature to be extracted comprises:
determining image data as the target data for the feature to be extracted; and
correspondingly, the feature information corresponding to each of the query vectors being used to determine an image classification result of the image data.

8. The method of claim 1, wherein the determining target data for a feature to be extracted comprises:
determining video data as the target data for the feature to be extracted; and
correspondingly, the feature information corresponding to each of the query vectors being used to determine a video action recognition result of the video data.

9. The method of claim 1, wherein the determining target data for a feature to be extracted comprises:
determining text data as the target data for the feature to be extracted; and
correspondingly, the feature information corresponding to each of the query vectors being used to determine a translation of the text data.

10. (canceled)

11. A non-transitory computer-readable medium, having a computer program stored thereon, wherein the program, when executed by a processing device, performs operations comprising:
determining target data for a feature to be extracted, and determining, based on the target data, a plurality of query vectors, a plurality of key vectors, and a plurality of value vectors;
determining a plurality of key-value pair information corresponding to each of the query vectors, wherein each of the key-value pair information is determined based on the plurality of key vectors, the plurality of value vectors, and a data sample, and the plurality of data samples for determining the plurality of key-value pair information are obtained by sampling based on a plurality of probability distributions, the plurality of probability distributions are determined based on the plurality of query vectors; and
performing, for each of the query vectors, a random mapping based on the query vector and the plurality of data samples, to obtain a plurality of random query vectors, and determining feature information corresponding to the query vector based on the plurality of random query vectors and the plurality of key-value pair information.

12-14. (canceled)

15. An electronic device, comprising:
a storage unit having a computer program stored thereon;
a processing unit configured to execute the computer program in the storage unit to perform operations comprising:
determining target data for a feature to be extracted, and determining, based on the target data, a plurality of query vectors, a plurality of key vectors, and a plurality of value vectors;
determining a plurality of key-value pair information corresponding to each of the query vectors, wherein each of the key-value pair information is determined based on the plurality of key vectors, the plurality of value vectors, and a data sample, and the plurality of data samples for determining the plurality of key-value pair information are obtained by sampling based on a plurality of probability distributions, the plurality of probability distributions are determined based on the plurality of query vectors; and
performing, for each of the query vectors, a random mapping based on the query vector and the plurality of data samples, to obtain a plurality of random query vectors, and determining feature information corresponding to the query vector based on the plurality of random query vectors and the plurality of key-value pair information.

16. The electronic device of claim 15, wherein the determining a plurality of key-value pair information corresponding to each of the query vectors comprises:
determining a probability distribution based on each of the query vectors, and performing, according to a first predetermined quantity, a sampling based on the probability distribution corresponding to each of the query vectors, to obtain the plurality of data samples corresponding to each of the query vectors, wherein the first predetermined quantity is used to represent an expected quantity of samples; and
determining, for each of the query vectors, the plurality of key-value pair information based on the plurality of key vectors, the plurality of value vectors, and the plurality of data samples corresponding to the query vector.

17. The electronic device of claim 15, wherein the determining a plurality of key-value pair information corresponding to each of the query vectors comprises:
dividing the plurality of query vectors into a plurality of query vector groups according to a second predetermined quantity, wherein the second predetermined quantity is used to represent an expected quantity of query vector groups, and the second predetermined quantity is smaller than a quantity of the plurality of query vectors;
determining a probability distribution based on each of the query vector groups, and sampling a data sample based on the probability distribution corresponding to each of the query vector groups, to obtain the plurality of data samples;
determining key-value pair information based on each of the data samples, the plurality of key vectors, and the plurality of value vectors, to obtain a plurality of shared key-value pair information; and
determining the plurality of shared key-value pair information as the plurality of key-value pair information corresponding to each of the query vectors.

18. The electronic device of claim 17, wherein the determining feature information corresponding to the query vector based on the plurality of random query vectors and the plurality of key-value pair information comprises:
determining a first similarity between a probability distribution corresponding to each of the query vector groups and a probability distribution corresponding to the plurality of query vector groups, and determining, for each of the query vectors, a second similarity between the query vector and an average query vector of each of the query vector groups;
determining computational weights based on the first similarity and the second similarity; and
performing, based on the computational weights, a weighted summation on the plurality of random query vectors and the plurality of key-value pair information, to obtain the feature information corresponding to the query vector.

19. The electronic device of claim 18, the operations further comprising:
determining, for the probability distribution corresponding to each of the query vector groups, an importance sampling weight corresponding to the probability distribution based on the probability distribution and a standard normal distribution;
the performing, based on the computational weights, a weighted summation on the plurality of random query vectors and the plurality of key-value pair information, to obtain the feature information corresponding to the query vector comprising:
determining a product of the computational weight and the importance sampling weight as a target computational weight; and
performing, based on the target computational weight, the weighted summation on the plurality of random query vectors and the plurality of key-value pair information, to obtain the feature information corresponding to the query vector.

20. The electronic device of claim 18, wherein the determining computational weights based on the first similarity and the second similarity comprises:
determining, for each of the query vector groups, a sum of the first similarity and the second similarity corresponding to the query vector group as the computational weights; or
determining, for each of the query vector groups, a sum of the first similarity and the second similarity corresponding to the query vector group as a total similarity, determining, based on the second similarity corresponding to each of the query vector groups, an average similarity between the query vector and an average query vector of the plurality of query vector groups, and subtracting the average similarity from the total similarity to obtain the computational weights.

21. The electronic device of claim 15, wherein the determining target data for a feature to be extracted comprises:
determining image data as the target data for the feature to be extracted; and
correspondingly, the feature information corresponding to each of the query vectors being used to determine an image classification result of the image data.

22. The electronic device of claim 15, wherein the determining target data for a feature to be extracted comprises:
determining video data as the target data for the feature to be extracted; and
correspondingly, the feature information corresponding to each of the query vectors being used to determine a video action recognition result of the video data.

23. The electronic device of claim 15, wherein the determining target data for a feature to be extracted comprises:
determining text data as the target data for the feature to be extracted; and
correspondingly, the feature information corresponding to each of the query vectors being used to determine a translation of the text data.

24. The non-transitory computer-readable medium of claim 11, wherein the determining a plurality of key-value pair information corresponding to each of the query vectors comprises:
determining a probability distribution based on each of the query vectors, and performing, according to a first predetermined quantity, a sampling based on the probability distribution corresponding to each of the query vectors, to obtain the plurality of data samples corresponding to each of the query vectors, wherein the first predetermined quantity is used to represent an expected quantity of samples; and
determining, for each of the query vectors, the plurality of key-value pair information based on the plurality of key vectors, the plurality of value vectors, and the plurality of data samples corresponding to the query vector.
